(19) United States
(12) Patent Application Publication
(10) Pub. No.: US 2026/0121808 A1
(43) Pub. Date: Apr. 30, 2026

(54) CHANNEL CHARACTERISTIC PREDICTIONS BASED AT LEAST IN PART ON A SUBSET OF DOWNLINK REFERENCE SIGNAL RESOURCES

(71) Applicant: QUALCOMM Incorporated, San Diego, CA (US)

(72) Inventors: Qiaoyu LI, Beijing (CN); Tianyang BAI, Mountain View, CA (US); Mahmoud TAHERZADEH BOROUJENI, San Diego, CA (US); Taesang YOO, San Diego, CA (US); Hamed PEZESHKI, San Diego, CA (US); Arumugam CHENDAMARAI KANNAN, San Diego, CA (US); Tao LUO, San Diego, CA (US)

(21) Appl. No.: 18/994,937

(22) PCT Filed: Jun. 22, 2023
(86) PCT No.: PCT/CN2023/101988

§ 371 Date: Jan. 15, 2025

(30) Foreign Application Priority Data
Sep. 28, 2022 (WO) PCT/CN2022/122014

(51) Int. Cl. H04L 5/00

(52) U.S. Cl. CPC H04L 5/005; H04L 5/0064

(57) ABSTRACT

Various aspects of the present disclosure generally relate to wireless communication. In some aspects, a user equipment (UE) may receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The UE may identify the subset of the first set of downlink reference signal resources based at least in part on the technique for identifying the subset of the first set of downlink reference signal resources. Numerous other aspects are described.

### CROSS-REFERENCE TO RELATED APPLICATION

This Patent Application claims priority to PCT Patent Application No. PCT/CN2022/122014, filed on Sep. 28, 2022, entitled “CHANNEL CHARACTERISTIC PREDICTIONS BASED AT LEAST IN PART ON A SUBSET OF DOWNLINK REFERENCE SIGNAL RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel characteristic predictions based at least in part on a subset of downlink reference signal resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The method may include identifying the subset of the first set of downlink reference signal resources based at least in part on the technique for identifying the subset of the first set of downlink reference signal resources.

Some aspects described herein relate to a method of wireless communication performed by a network node. The method may include selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The method may include transmitting, to a UE, an indication of the technique for identifying the subset of the first set of downlink reference signal resources.

Some aspects described herein relate to a UE for wireless communication. The UE may include one or more memories and one or more processors coupled to the one or more memories. The one or more processors may be configured to receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The one or more processors may be configured to identify the subset of the first set of downlink reference signal resources based at least in part on the technique for identifying the subset of the first set of downlink reference signal resources.

Some aspects described herein relate to a network node for wireless communication. The network node may include one or more memories and one or more processors coupled to the one or more memories. The one or more processors may be configured to select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The one or more processors may be configured to transmit, to a UE, an indication of the technique for identifying the subset of the first set of downlink reference signal resources.

Some aspects described herein relate to a non-transitory computer-readable medium that stores a set of instructions for wireless communication by a UE. The set of instructions, when executed by one or more processors of the UE, may cause the UE to receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The set of instructions, when executed by one or more processors of the UE, may cause the UE to identify the subset of the first set of downlink reference signal resources based at least in part on the technique for identifying the subset of the first set of downlink reference signal resources.

Some aspects described herein relate to a non-transitory computer-readable medium that stores a set of instructions for wireless communication by a network node. The set of instructions, when executed by one or more processors of the network node, may cause the network node to select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The set of instructions, when executed by one or more processors of the network node, may cause the network node to transmit, to a UE, an indication of the technique for identifying the subset of the first set of downlink reference signal resources.

Some aspects described herein relate to an apparatus for wireless communication. The apparatus may include means for receiving, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The apparatus may include means for identifying the subset of the first set of downlink reference signal resources based at least in part on the technique for identifying the subset of the first set of downlink reference signal resources.

Some aspects described herein relate to an apparatus for wireless communication. The apparatus may include means for selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The apparatus may include means for transmitting, to a UE, an indication of the technique for identifying the subset of the first set of downlink reference signal resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information reference signal beam management procedures, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of an artificial intelligence/machine learning based beam management procedure, in accordance with the present disclosure.

FIGS. 7A-7B are diagrams illustrating an example associated with channel characteristic predictions based at least in part on a subset of downlink reference signal resources, in accordance with the present disclosure.

FIG. 8 is a diagram of an example associated with channel characteristic predictions based at least in part on a subset of downlink reference signal resources, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

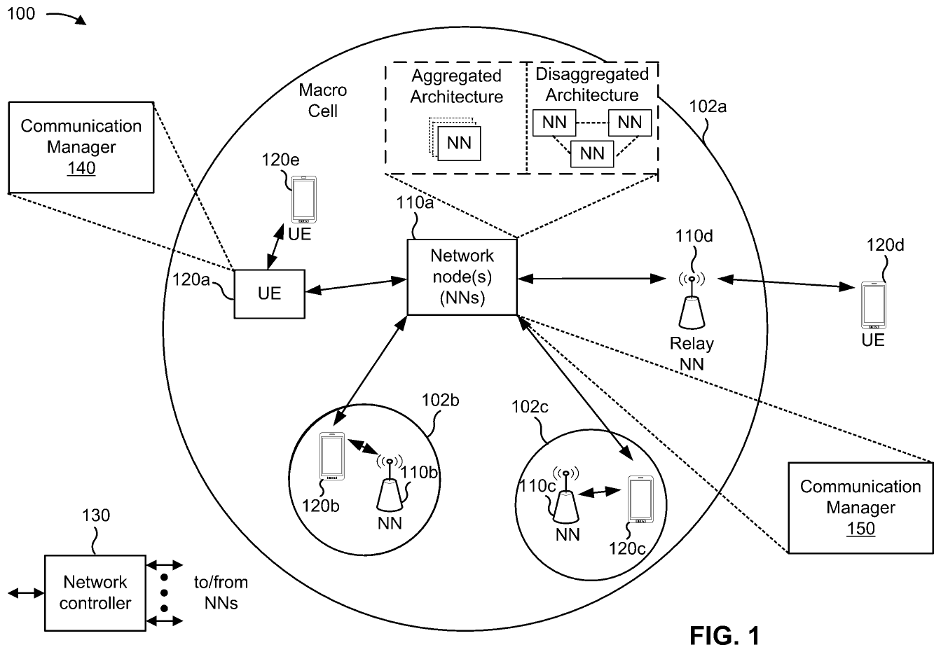

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node 110, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and identify the subset of the first set of downlink reference signal resources based at least in part on the technique for identifying the subset of the first set of downlink reference signal resources. Additionally, or alternatively, the communication manager 140 may perform one or more other operations described herein.

In some aspects, the network node 110 may include a communication manager 150. As described in more detail elsewhere herein, the communication manager 150 may select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and transmit, to a UE 120, an indication of the technique for identifying the subset of the first set of downlink reference signal resources. Additionally, or alternatively, the communication manager 150 may perform one or more other operations described herein.

As indicated above, FIG. 1 is provided as an example. Other examples may differ from what is described with regard to FIG. 1.

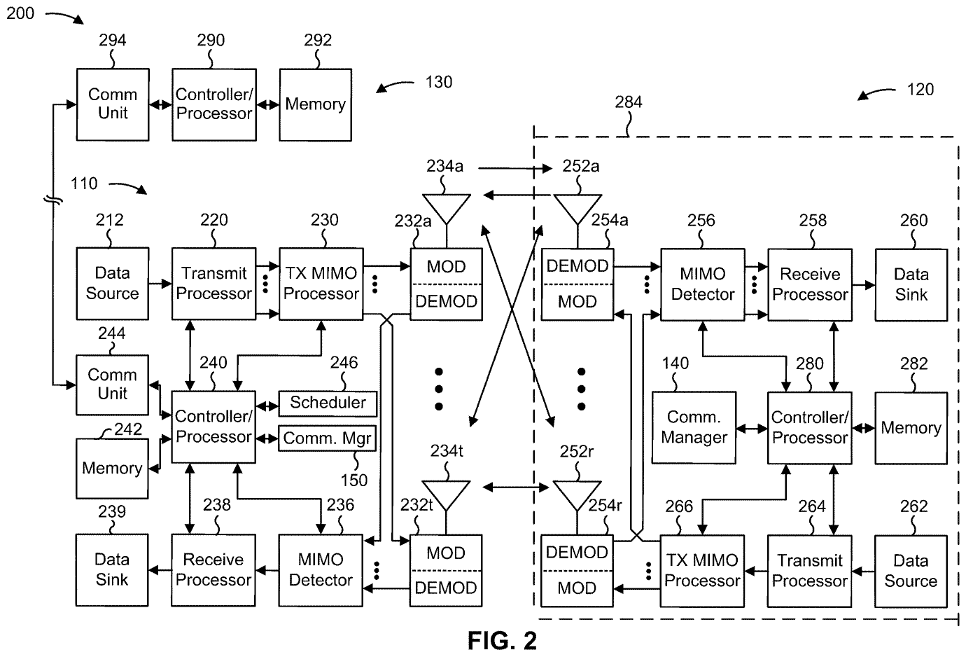

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

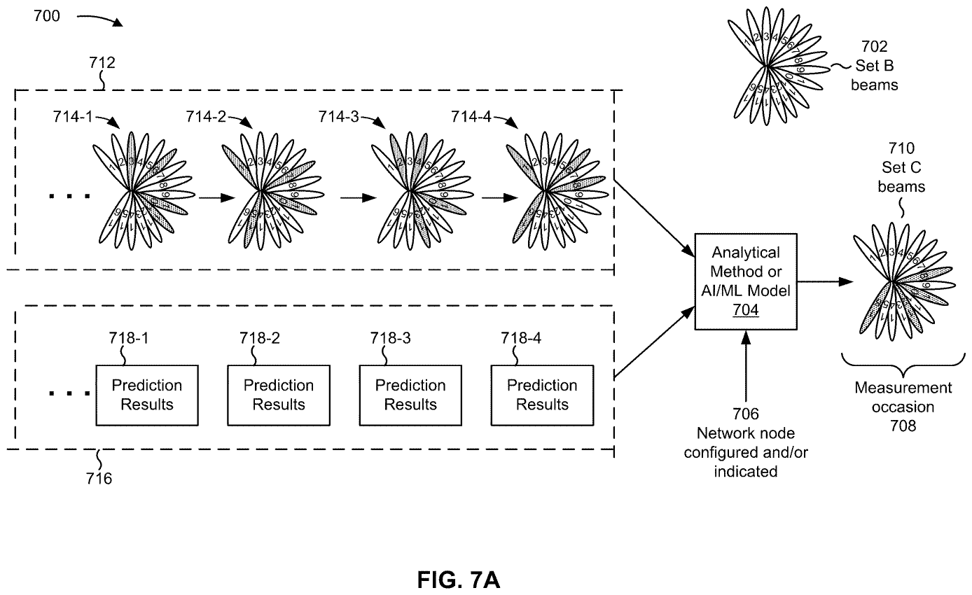

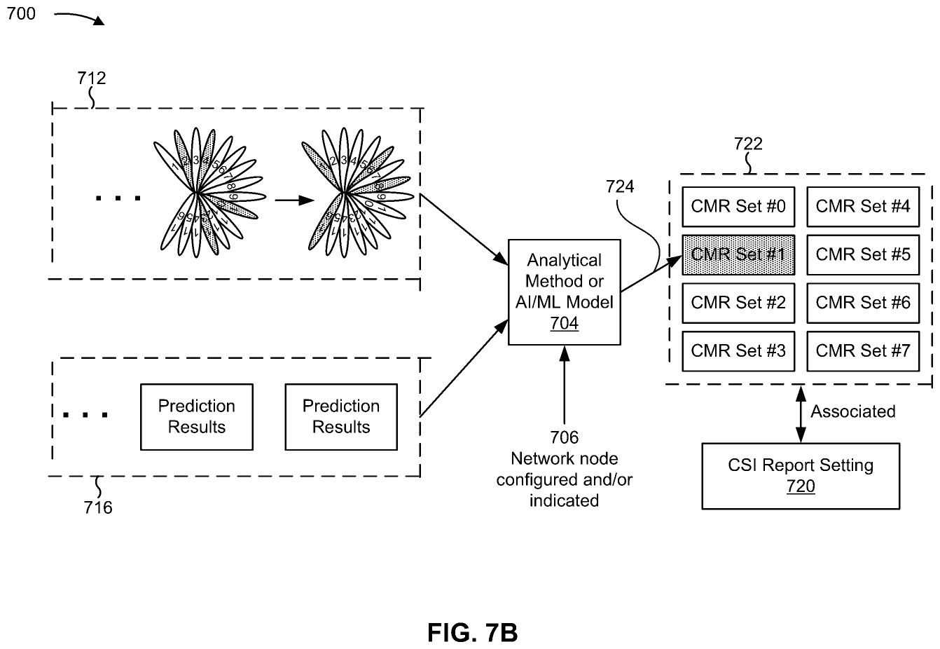

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-12).

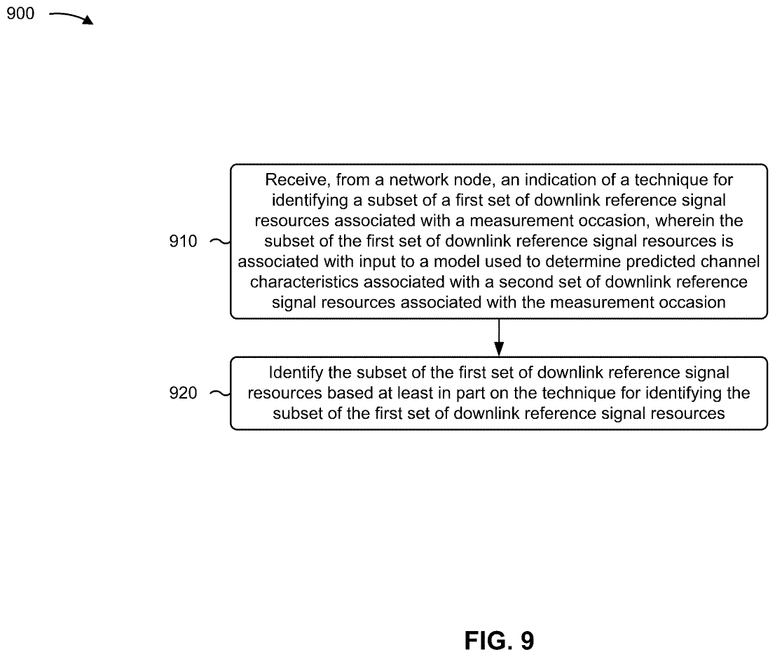

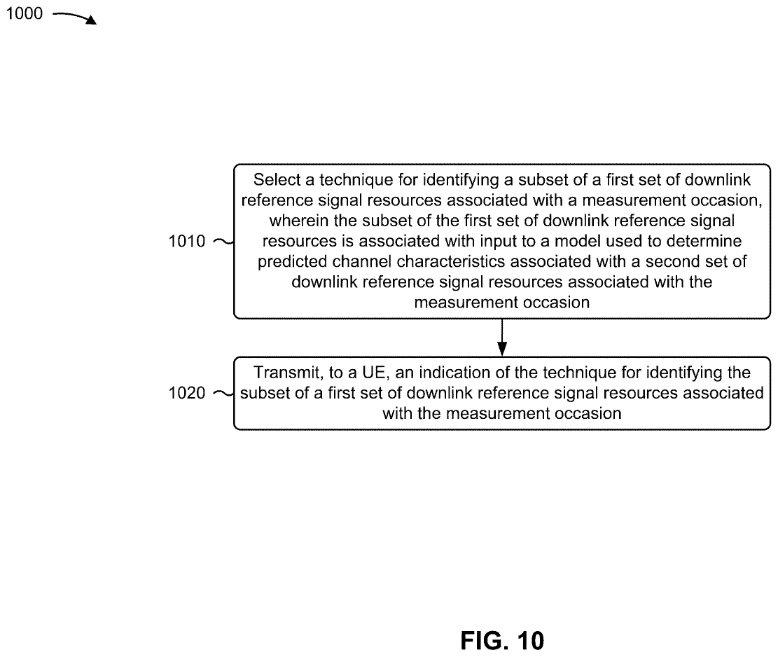

The controller/processor 240 of the network node 110, the controller/processor 280 of the UE 120, and/or any other component(s) of FIG. 2 may perform one or more techniques associated with channel characteristic predictions based at least in part on a subset of downlink reference signal resources, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a network node 110, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and/or means for identifying the subset of the first set of downlink reference signal resources based at least in part on the technique for identifying the subset of the first set of downlink reference signal resources. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and/or means for transmitting, to a UE 120, an indication of the technique for identifying the subset of the first set of downlink reference signal resources. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

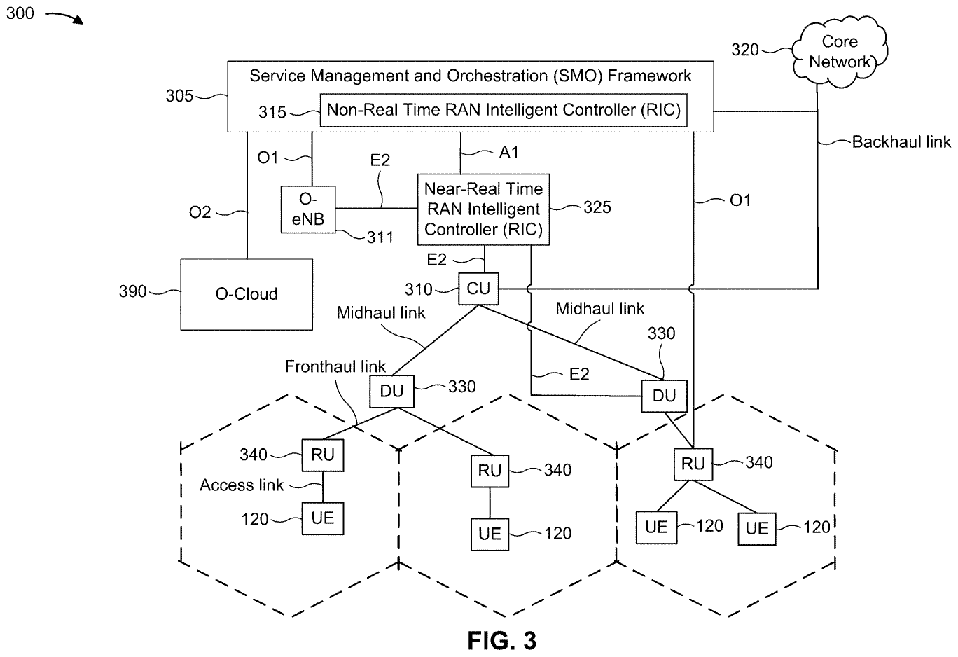

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

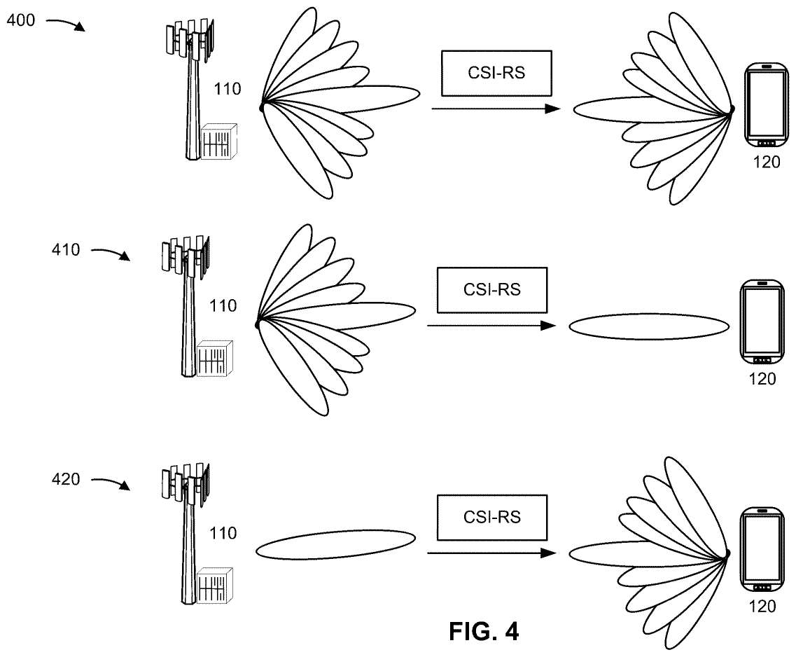

FIG. 4 is a diagram illustrating examples 400, 410, and 420 of channel state information (CSI) reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node 110 may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

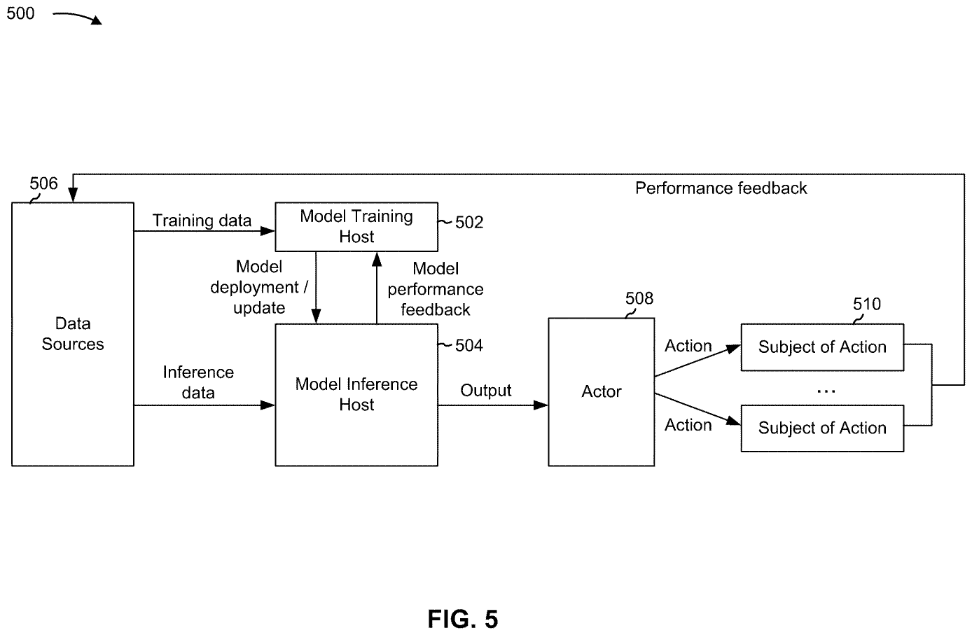

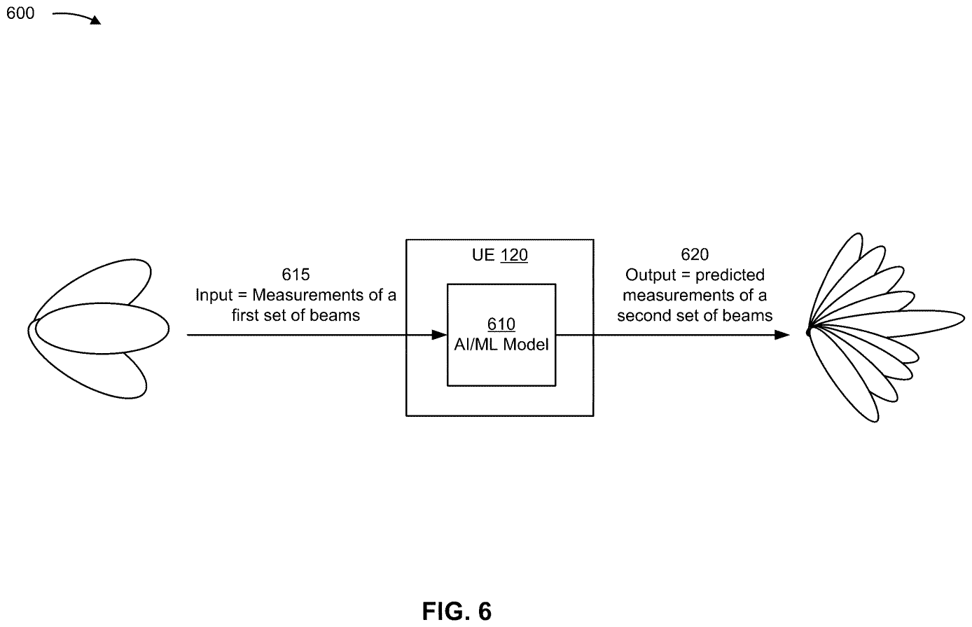

In some aspects, channel characteristics associated with one or more of the beams described above in connection with the various beam management procedures may be directly measured by a wireless communication device, such as by the UE 120. However, in some other aspects, channel characteristics associated with one or more of the beams described above in connection with the various beam management procedures may be inferred and/or predicted based at least in part on channel characteristics associated with other beams, such as via use of an artificial intelligence (AI) and/or machine learning (ML) model. Aspects of using channel characteristics of certain beams to predict channel characteristics associated with other beams are described in more detail below in connection with FIGS. 5 and 6.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE 120 transmit beam.

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE 120, a network node 110, a base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE 120, a DU, or an RU, and if the output from the model inference host 504 is associated with transmission and/or reception scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a transmission and/or reception beam based on the output. If the actor 508 determines to act based on the output, the actor 508 may indicate the action to at least one subject of action 510. For example, if the actor 508 determines to change/modify a transmission and/or reception beam for a communication between the actor 508 and the subject of action 510 (e.g., a UE 120), then the actor 508 may transmit a beam (re-)configuration or a beam switching indication to the subject of action 510. The actor 508 may modify its transmission and/or reception beam based on the beam (re-)configuration, such as switching to a new transmission and/or reception beam or applying different parameters for a transmission and/or reception beam, among other examples. As another example, the actor 508 may be a UE 120 and the output from the model inference host 504 may be associated with beam management. For example, the output may be one or more predicted measurement values for one or more beams. The actor 508 (e.g., a UE 120) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training.

For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

FIG. 6 is a diagram illustrating an example 600 of an AI/ML based beam management procedure, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurement values associated with a first set of beams. For example, a network node 110 may transmit one or more signals via respective beams from the first set of beams. The UE 120 may perform measurements (e.g., L1 RSRP measurements or other measurements) of the first set of beams or a subset thereof to obtain a first set of measurement values (sometimes referred to as channel characteristics). For example, each beam (or else a subset thereof), from the first set of beams, may be associated with one or more measurements performed by the UE 120.

The UE 120 may input the first set of measurement values (e.g., L1 RSRP measurement values) into the AI/ML model 610 along with information associated with the first set of beams (or a subset thereof) and/or a second set of beams, such as a beam direction (e.g., spatial direction), beam width, beam shape, and/or other characteristics of the respective beams from the first set of beams (or subset thereof) and/or the second set of beams.

As shown by reference number 620, the AI/ML model 610 may output one or more predictions. The one or more predictions may include predicted measurement values and/or channel characteristics (e.g., predicted L1 RSRP measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook-based spatial domain selection or prediction. As another example, multiple measurement reports or values, collected at different points in time, may be input to the AI/ML model 610. This may enable the AI/ML model 610 to output codebook-based and/or non-codebook-based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedures, beam failure and/or beam blockage predictions, and/or radio link failure predictions, among other examples.

In some examples, beam measurement predictions may be performed by a UE 120 (e.g., as depicted in FIG. 6) and/or by a network node 110 in a similar manner as described above. For example, a network node 110 may receive one or more measurement values (e.g., from measurements performed by a UE 120) and may use an AI/ML model 610 to predict one or more measurement values (e.g., of other beams) based at least in part on the one or more measurement values associated with measurements performed by the UE 120. For example, predictions may be performed by a network node 110 because the network node 110 may have more processing resources and/or a greater processing capability than a UE 120. Additionally, the network node 110 may have access to historical measurement reports and/or measurement reports from other UEs that may be used as inputs to the AI/ML model 610 (e.g., which may improve an accuracy of an output of the AI/ML model 610). Predictions may be performed by the UE 120 because the UE 120 may have access to filtered measurements of all beams (e.g., not all measurements may be reported to the network node 110). Additionally, the UE 120 may have information related to the receive beam(s) used to derive or perform the measurements (e.g., which may be a useful input for the AI/ML model 610). As another example, the measurement information at the UE 120 may be “raw” or non-quantized, thereby providing more information that can be input into the AI/ML model 610. Further, the UE 120 may have knowledge of an orientation or a rotational position of the UE 120.

In some examples, the first set of beams (e.g., that are measured) may be referred to as Set B beams and the second set of beams (e.g., that are associated with predicted measurement values) may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold), as depicted in FIG. 6. In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

In some examples, a UE 120 may be configured with the first set of beams (e.g., the Set B beams), but the UE 120 may use only a subset of the first set of beams to determine predictive channel characteristics associated with the second set of beams (e.g., the Set A beams). Put another way, the measurements of the Set B beams indicated by reference number 615, which are input into the AI/ML model 610 in order to determine predicted channel characteristics associated with the Set A beams, may be associated with a subset of the Set B beams. This may be because when the AI/ML model 610 resides at the UE 120 as shown in FIG. 6, the AI/ML model 610 may be simplified to reduce memory and/or computational resources, and thus the AI/ML model 610 may not be capable of inputting all measurement values and/or channel characteristics associated with all beams of the Set B beams. For example, a network node 110 may configure a UE 120 with 64 SSBs for the UE 120 to measure (e.g., the Set B beams may include 64 beams), but the UE 120 may only use measurement values and/or channel characteristics associated with eight SSBs as input to the AI/ML model 610 (e.g., the number of SSB identifiers and/or associated L1 RSRPs to be used as inputs at a given time domain measurement occasion may be eight). The number of beams associated with the first set of beams (e.g., 64 in the above-described example) is sometimes referred to as N₁, and the number of beams associated with the subset of the first set of beams used as input to the AI/ML model 610 is sometimes referred to as N₂. Thus, returning to the above example, in some cases N₂ may be much smaller than N₁ (e.g., N₁>>N₂).

In some cases, a UE 120 may use another AI/ML model (e.g., a model different from the AI/ML model 610) and/or an analytical method to determine which subset of the first set of beams should be used as input to the AI/ML model 610. For example, previously used SSBs (e.g., the previously used beams associated with N₂) and/or most recently or previously predicted L1 RSRPs of the second set of beams (e.g., the Set A beams) may be used as input to the AI/ML model and/or the analytical method to determine a subset of the first set of beams to be used as input to the AI/ML model 610. In some cases, the subset of the first set of beams that are used as input to the AI/ML model 610 to predict channel characteristics associated with the second set of beams (e.g., the Set A beams) are referred to as Set C beams.

The AI/ML model and/or analytical method used to determine the Set C beams may vary according to UE 120 implementation and/or may be transparent to the network node 110. Accordingly, the Set C beams selected by the UE 120 may result in inaccurate channel characteristic predictions, leading to the network node 110 and/or the UE 120 to communicate using poor-quality beams and/or channels. This may result in degraded communication quality, leading to error-prone communications and thus increased power, computing, and network resource consumption for purposes of correcting communication errors. Additionally, or alternatively, by communicating using poor-quality beams and/or channels, the UE 120 and/or the network node 110 may experience increased latency, decreased throughput, and otherwise unreliable communications or even radio link failure.

Some techniques and apparatuses described herein enable signaling from a network node 110 to a UE 120 to configure and/or indicate a technique (e.g., an analytical method and/or an AI/ML model) used to determine Set C beams out of Set B beams for purposes of predicting channel characteristics associated with Set A beams. For example, in some aspects, a network node 110 may select a technique (e.g., an analytical method and/or an AI/ML model) for identifying a subset (e.g., Set C beams) of a first set of downlink reference signal resources (e.g., Set B beams) associated with a particular measurement occasion, and the network node 110 may transmit, to the UE 120, an indication of the technique for identifying the subset of the first set of downlink reference signal resources. Based at least in part on the technique indicated by the network node 110, the UE 120 may identify the subset of the first set of downlink reference signal resources (e.g., the set C beams), and thus may determine predicted channel characteristics associated with the second set of downlink reference signal resources (e.g., the Set A beams) associated with the measurement occasion based at least in part on the subset of the first set of downlink reference signal resources. As a result, the Set C beams selected by the UE 120 may result in more accurate and robust channel characteristic predictions, leading to the network node 110 and/or the UE 120 to communicate using high-quality beams and/or channels. This may result in improved communication quality, leading to low-error-rate communications channels and thus reduced power, computing, and network resource consumption that would have otherwise been used for purposes of correcting communication errors. Additionally, or alternatively, by communicating using high-quality beams and/or channels, the UE 120 and/or the network node 110 may experience decreased latency, increased throughput, and otherwise more reliable communication channels and thus more efficient usage of network resources.

As indicated above, FIG. 6 is provided as an example. Other examples may differ from what is described with regard to FIG. 6.

FIGS. 7A-7B are diagrams illustrating an example 700 associated with channel characteristic predictions based at least in part on a subset of downlink reference signal resources, in accordance with the present disclosure.

As shown by reference number 702, a UE 120 may be configured with a first set of downlink reference signals (e.g., CSI-RSs, SSBs, or similar reference signals) associated with input to an AI/ML model (e.g., AI/ML model 610) that is used to determine predicted channel characteristics associated with a second set of downlink reference signal resources associated with a measurement occasion. As described above, the first set of downlink reference signals may be referred to as Set B beams, and the second set of downlink reference signals may be referred to as Set A beams. In the depicted example 700, the Set B beams include 16 downlink reference signals and/or beams, indexed as 1 to 16 in FIGS. 7A and 7B. In some other aspects, more or less downlink reference signals and/or beams may be implemented without departing from the scope of the disclosure. For example, in some aspects, the Set B beams may include 64 downlink reference signals and/or beams (e.g., 64 SSBs), as described above in connection with FIG. 6.

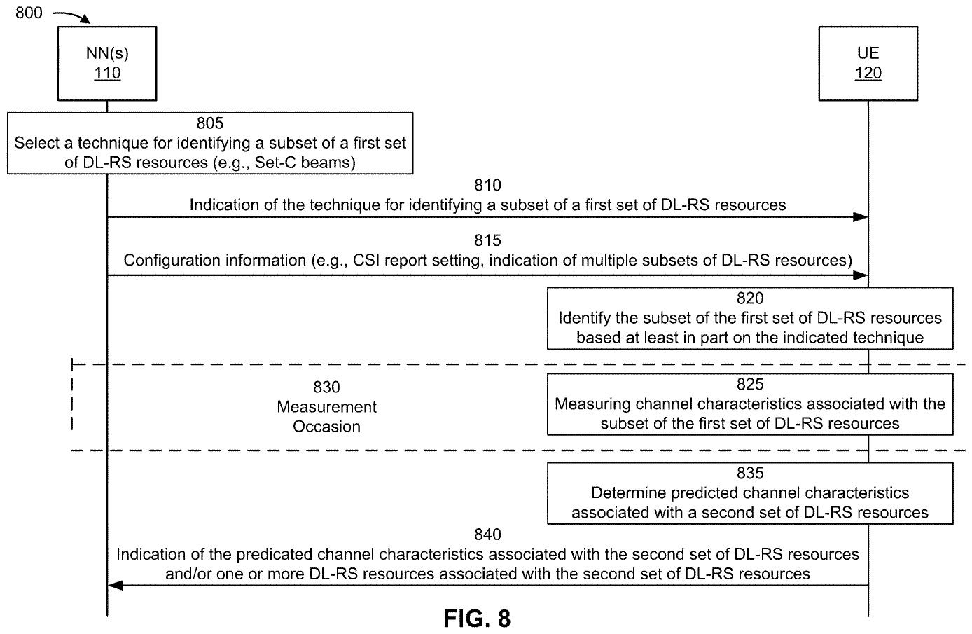

In some aspects, the UE 120 may be associated with an analytical method or AI/ML model 704, which may be used to determine a subset of the Set B beams to be used as input to an AI/ML model (e.g., AI/ML model 610) used to determine predicted channel characteristics associated with the Set A beams. In some aspects, the network node 110 may select the particular analytical method or AI/ML model 704 to be used by the UE 120 for a given measurement occasion, the network node 110 may configure the UE 120 with the particular analytical method or AI/ML model 704 to be used by the UE 120 for the given measurement occasion, and/or the network node 110 may indicate, to the UE 120, the particular analytical method or AI/ML model 704 to be used by the UE 120 for the given measurement occasion, as indicated by reference number 706. Aspects of configuring and/or signaling a particular analytical method or AI/ML model 704 to be used by the UE 120 for the given measurement occasion are described in more detail below in connection with FIG. 8.

In some aspects, the analytical method or AI/ML model 704 may be used to determine a subset of the Set B beams to be used as input to an AI/ML model (e.g., AI/ML model 610) for a measurement occasion 708. The subset of the Set B beams to be used as input to an AI/ML model may be referred to as Set C beams, which are shown by using stippling in the beams indicated by reference number 710. More particularly, in the depicted example, the Set C beams for measurement occasion 708 include four of the sixteen Set B beams: beam 8, beam 10, beam 12, and beam 16. Although in the depicted example 700 the Set C beams includes 4 downlink reference signals and/or beams, in some other aspects, more or less downlink reference signals and/or beams may be implemented without departing from the scope of the disclosure. For example, in some aspects, the Set B beams may include 64 downlink reference signals and/or beams (e.g., 64 SSBs) and the Set C beams may include a subset of eight of the 64 downlink reference signals and/or beams, as described above in connection with FIG. 6.

In some aspects, input to the analytical method or AI/ML model 704 may be associated with one or more previously determined subsets of the first set of downlink reference signal resources associated with one or more measurement occasions preceding the measurement occasion 708 (e.g., a number of previously determined Set C beams), as indicated by reference number 712. For example, in the aspects shown in FIG. 7A, four previously determined subsets of the first set of downlink reference signal resources 714 (e.g., four previously determined Set C beams) are shown, indexed as 714-1 to 714-4. Each of the previously determined subsets of the first set of downlink reference signal resources 714 may correspond to a subset of the first set of downlink reference signal resources (e.g., Set C beams) determined in a corresponding measurement occasion preceding the measurement occasion 708. More particularly, the first previously determined subset of the first set of downlink reference signal resources 714-1 may correspond to a first measurement occasion preceding the measurement occasion 708, and may include (as shown using stippling in FIG. 7A) beam 3, beam 6, beam 10, and beam 11. The second previously determined subset of the first set of downlink reference signal resources 714-2 may correspond to a second measurement occasion preceding the measurement occasion 708, and may include beam 1, beam 7, beam 10, and beam 15. The third previously determined subset of the first set of downlink reference signal resources 714-3 may correspond to a third measurement occasion preceding the measurement occasion 708, and may include beam 2, beam 4, beam 10, and beam 13. And the fourth previously determined subset of the first set of downlink reference signal resources 714-4 may correspond to a fourth measurement occasion preceding the measurement occasion 708, and may include beam 1, beam 6, beam 8, and beam 16. Additionally, or alternatively, input to the analytical method or AI/ML model 704 may be associated with additional information associated with the one or more previously determined subsets of the first set of downlink reference signal resources indicated by reference number 712, such as previously measured channel characteristics and/or measurement values associated with each subset of the first set of downlink reference signal resources 714.

In some other aspects, input to the analytical method or AI/ML model 704 may be associated with predicted channel characteristics of the second set of downlink reference signal resources (e.g., Set A beams) associated with one or more measurement occasions preceding the measurement occasion 708, as indicated by reference number 716. For example, in the aspects shown in FIG. 7A, four sets of previously determined predicted channel characteristics of the second set of downlink reference signal resources 718 (indicated as “prediction results” in FIG. 7A) are shown, indexed as 718-1 to 718-4. Each of the sets of previously determined predicted channel characteristics of the second set of downlink reference signal resources 718 may correspond to a set of predicted channel characteristics of the second set of downlink reference signal resources (e.g., Set A beams) determined in a corresponding measurement occasion preceding the measurement occasion 708, such as by using an AI/ML model (e.g., AI/ML model 610) or similar technique.

Based at least in part on the one or more previously determined subsets of the first set of downlink reference signal resources associated with one or more measurement occasions preceding the measurement occasion 708 and/or information associated therewith (e.g., channel characteristics associated with each previously determined subset of beams), as indicated by reference number 712, and/or the predicted channel characteristics of the second set of downlink reference signal resources associated with the one or more measurement occasions preceding the measurement occasion 708, as indicated by reference number 716, the UE 120 may determine, using the analytical method or AI/ML model 704, the Set C beams to be used for the measurement occasion 708, as indicated by reference number 710. Additionally, or alternatively, the analytical method or AI/ML model 704 may utilize additional input instead of, or in addition to, the one or more measurement occasions preceding the measurement occasion 708, as indicated by reference number 712, and/or the predicted channel characteristics of the second set of downlink reference signal resources associated with one or more measurement occasions preceding the measurement occasion 708, as indicated by reference number 716. For example, in some aspects, input to the analytical method or AI/ML model 704 may be based at least in part on measured channel characteristics of the first set of downlink reference signals (e.g., the Set B beams), indicated by reference number 702, at the measurement occasion 708, and/or measured channel characteristics of the first set of downlink reference signals in one more measurement occasions preceding the measurement occasion 708.

In some aspects, determining the subset of the Set B beams (e.g., the Set C beams indicated by reference number 710) to be used as input the AI/ML model (e.g., AI/ML model 610) for the measurement occasion 708 may be based at least in part on one or more channel measurement resource (CMR) sets, as shown in FIG. 7B. For example, in some aspects, a UE 120 may receive, from a network node 110, a CSI report setting 720, which may be used to configure a CSI report used by the UE 120 to report, to the network node 110, the predicted channel characteristics associated with the second set of downlink reference signal resources (e.g., the Set A beams) associated with the measurement occasion 708. In such aspects, the CSI report setting 720 may indicate or otherwise be associated with multiple CMR sets, indicated by reference number 722, such as eight CMR sets indexed as CMR set #0 to CMR set #7 in FIG. 7B. Each CMR set may be associated with a candidate set of beams to serve as the Set C beams for the measurement occasion 708. Put another way, the CSI report setting 720 may be associated with multiple CMR sets (e.g., CMR set #0 to CMR set #7 in the depicted example) as options of the subsets from the first set of downlink reference signal resources (e.g., as options of the Set C beams). In such aspects, the network node 110 indicated and/or configured analytical method or AI/ML model 704 may output at least a CMR set identifier (sometimes referred to as CMR-Set-ID) associated with the Set C beams, as indicated by the arrow accompanying reference number 724 in FIG. 7B.

Based at least in part on the network node 110 signaling, to the UE 120, an indication of a technique for determining the Set C beams, the UE 120 and/or the network node 110 may conserve computing, power, network, and/or communication resources that may have otherwise been consumed communicating based at least in part on channel predictions determined based at least in part on Set C beams chosen autonomously by the UE 120 and/or determined according to UE 120-specific implementation. For example, based at least in part on the network node 110 signaling, to the UE 120, an indication of a technique for determining the Set C beams, the UE 120 and the network node 110 may communicate with a reduced error rate, which may conserve computing, power, network, and/or communication resources that may have otherwise been consumed to detect and/or correct communication errors. Further details of the network node 110 signaling, to the UE 120, an indication of a technique for determining the Set C beams is described in more detail below in connection with FIG. 8.

As indicated above, FIGS. 7A-7B are provided as examples. Other examples may differ from what is described with respect to FIGS. 7A-7B.

FIG. 8 is a diagram of an example 800 associated with channel characteristic predictions based at least in part on a subset of downlink reference signal resources, in accordance with the present disclosure. As shown in FIG. 8, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 8. For example, in some aspects, the UE 120 and the network node 110 may have established a wireless connection via beamforming, such as by using one or more of the beam management procedures described above in connection with FIG. 4.

As shown by reference number 805, the network node 110 may select a technique for identifying a subset of a first set of downlink reference signal (DL-RS) resources associated with a measurement occasion (e.g., measurement occasion 708). In some aspects, the first set of downlink reference signal resources may correspond to Set B beams, such as the Set B beams described above in connection with reference number 702. Moreover, in some aspects, the subset of the first set of downlink reference signal resources may correspond to Set C beams, such as the Set C beams described above in connection with reference number 710. In that regard, the subset of the first set of downlink reference signal resources (e.g., the Set C beams) may be associated with input to a model (e.g., the AI/ML model 610) used to determine predicted channel characteristics associated with a second set of downlink reference signal resources (e.g., Set A beams) associated with the measurement occasion. In some aspects, the second set of downlink reference signal resources (e.g., the Set A beams) may be associated with real downlink reference signal resources and/or virtual downlink reference signal resources.

In some aspects, the technique for identifying the subset of the first set of downlink reference signal resources associated with a measurement occasion may correspond to the analytical method or AI/ML model 704 described above in connection with FIGS. 7A and 7B. In that regard, in some aspects the technique for identifying the subset of the first set of downlink reference signal resources associated with the measurement occasion may correspond to an analytical method and/or formula for identifying the subset of the first set of downlink reference signal resources, while, in some other aspects, the technique for identifying the subset of the first set of downlink reference signal resources associated with the measurement occasion may correspond to an AI/ML model for identifying the subset of the first set of downlink reference signal resources. Aspects of the technique for identifying the subset of the first set of downlink reference signal resources associated with the measurement occasion are described in more detail below in connection with reference number 820.

A shown by reference number 810, the network node 110 may transmit, and the UE 120 may receive, an indication of the technique for identifying the subset of the first set of downlink reference signal resources associated with the measurement occasion. In some aspects, the indication of the technique for identifying the subset of the first set of downlink reference signal resources associated with the measurement occasion may be indicated via configuration information, such as via an RRC configuration or reconfiguration message transmitted by the network node 110 to the UE 120. In such aspects, the indication of the technique for identifying the subset of the first set of downlink reference signal resources associated with the measurement occasion may be transmitted as part of another configuration communication and/or may be transmitted with additional configuration information, such as the configuration information described below in connection with reference number 815. In some other aspects, the network node 110 may transmit the indication of the technique for identifying the subset of the first set of downlink reference signal resources associated with the measurement occasion via a MAC-CE communication, via a DCI communication, or via a similar communication.

As shown by reference number 815, the network node 110 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may include the indication of the of the technique for identifying the subset of the first set of downlink reference signal resources associated with the measurement occasion, as described above in connection with reference number 810. Additionally, or alternatively, the configuration information may include additional configuration information, such as an indication of multiple candidate subsets of downlink reference signal resources (e.g., multiple candidate Set C beams). More particularly, in some aspects, the configuration information may include a configuration of multiple CMR sets (e.g., the multiple CMR sets indicated by reference number 722 in FIG. 7B). For example, the network node 110 may transmit, and the UE 120 may receive, a CSI report setting (e.g., CSI report setting 720) associated with a CSI report used to report the predicted channel characteristics associated with the second set of downlink reference signal resources associated with the measurement occasion (which is described in more detail below in connection with reference number 840). In such aspects, the CSI report setting may indicate the multiple CMR sets.

The UE 120 may configure itself based at least in part on the configuration information. In some aspects, the UE 120 may be configured to perform one or more operations described herein based at least in part on the configuration information.

As shown by reference number 820, the UE 120 may identify the subset of the first set of downlink reference signal resources (e.g., the UE 120 may identify the Set C beams) based at least in part on the technique for identifying the subset of the first set of downlink reference signal resources. For example, the UE 120 may identify the subset of the first set of downlink reference signal resources using the analytical method or AI/ML model 704 described above in connection with FIGS. 7A and 7B. In that regard, the technique for identifying a subset of a first set of downlink reference signal resources associated with a measurement occasion is associated with one of a formula or a machine-learning model. More particularly, in some aspects, the technique for identifying the subset of the first set of downlink reference signal resources may be based at least in part on one or more previously determined subsets of the first set of downlink reference signal resources associated with one or more measurement occasions preceding the measurement occasion, such as described above in connection with reference number 712.

Additionally, or alternatively, the technique for identifying the subset of the first set of downlink reference signal resources may be further based at least in part on channel characteristics associated with the one or more previously determined subsets of the first set of downlink reference signal resources associated with the one or more measurement occasions preceding the measurement occasion. As used herein, channel characteristics may refer to one or more measurement values or associated information associated with a measured reference signal (e.g., beam) in a measurement occasion. For example, in some aspects, the channel characteristics associated with a reference signal (e.g., beam) may include an RSRP measurement associated with the reference signal, a signal-to-noise-plus-interference ratio (SINR) associated with the reference signal, a precoding matrix indicator (PMI) associated with the reference signal, a CQI associated with the reference signal, a CSI-RS resource indicator (CRI) associated with the reference signal, or a rank indication (RI) associated with the reference signal.

In some aspects, the technique for identifying the subset of the first set of downlink reference signal resources associated with the measurement occasion may be based at least in part on a formula (e.g., an analytical method) associated with the channel characteristics associated with the one or more previously determined subsets of the first set of downlink reference signal resources. For example, in some aspects, resources with predicted and measured channel characteristics (e.g., predicted and/or measured L1 RSRPs) associated with the measurement occasion that are greater than a certain threshold may be identified as the subset of the first set of downlink reference signal resources (e.g., the Set-C beams). In some other aspects, the technique for identifying the subset of the first set of downlink reference signal resources associated with the measurement occasion may be based at least in part on an AI and/or ML model associated with the channel characteristics associated with the one or more previously determined subsets of the first set of downlink reference signal resources. For example, the UE 120 may be configured with an AI/ML model for which inputs include the one or more previously determined subsets of the first set of downlink reference signal resources associated with one or more measurement occasions preceding the measurement occasion (described above in connection with reference number 712), channel characteristics associated with the one or more previously determined subsets of the first set of downlink reference signal resources associated with the one or more measurement occasions preceding the measurement occasion, measured channel characteristics of the first set of downlink reference signal resources at the measurement occasion and/or measurement results associated with first set of downlink reference signal resources and preceding the measurement occasion, or predicted channel characteristics of the second set of downlink reference signal resources associated with a one or more measurement occasions preceding the measurement occasion (described above in connection with reference number 716), among other information.

In some aspects, identifying the subset of the first set of downlink reference signal resources may include identifying identifiers or similar information associated with each downlink reference signal resource (e.g., with each beam) and/or associated the set of downlink reference signal resource (e.g., the Set C beams), and/or related information such as channel characteristics associated with one or more identifiers. For example, in some aspects, identifying the subset of the first set of downlink reference signal resources may include identifying resource identifiers associated with the subset of the first set of downlink reference signal resources. In some other aspects, identifying the subset of the first set of downlink reference signal resources may include identifying channel characteristics associated with the subset of the first set of downlink reference signal resources. In some other aspects, and as described above in connection with reference numbers 720-724, identifying the subset of the first set of downlink reference signal resources may include identifying an identifier associated with a CMR set, of multiple CMR sets configured for the UE 120, that is associated with the subset of the first set of downlink reference signal resources, which is described more detail below in connection with reference number 840.

As shown by reference number 825, in some aspects the UE 120 may measure channel characteristics associated with the subset of the first set of downlink reference signal resources (e.g., the UE 120 may measure channel characteristics associated with the Set C beams). Moreover, the UE 120 may measure the channel characteristics associated with the subset of the first set of downlink reference signal resources in a measurement occasion 830 (e.g., measurement occasion 708), which may be a time domain measurement occasion for which the UE 120 will be determining predicted channel characteristics associated with the second set of downlink reference signals (e.g., Set A beams) using an AI/ML model (e.g., the AI/ML model 610), or a similar technique. As described above in connection with reference number 820, in some aspects, the measured channel characteristics associated with the subset of the first set of downlink reference signal resources may be associated with (e.g., used as) input to a model used to determine the predicted channel characteristics associated with the second set of downlink reference signal resources (e.g., the AI/ML model 610). In some aspects, the channel characteristics associated with the subset of the first set of downlink reference signal resources may be associated with at least one of an RSRP measurement, an SINR, a PMI, a CQI, a CRI, or an RI.

As shown by reference number 835, the UE 120 may determine the predicted channel characteristics associated with the second set of downlink reference signal resources (e.g., the Set A beams) associated with the measurement occasion 830 (e.g., measurement occasion 708) based at least in part on the subset of the first set of downlink reference signal resources (e.g., the Set C beams). In some aspects, in addition to the subset of the first set of downlink reference signal resources (e.g., the Set C beams), one or more channel characteristics associated with the first set of downlink reference signal resources may be used as input to a model (e.g., AI/ML model 610) used to determine predicted channel characteristics associated with the second set of downlink reference signals (e.g., Set A beams).

As shown by reference number 840, the UE 120 may report, to the network node 110, an indication of the predicted channel characteristics associated with the second set of downlink reference signal resources (e.g., the Set A beams) associated with the measurement occasion 830 (e.g., measurement occasion 708). In some aspects, the UE 120 may report the indication of the predicted channel characteristics associated with the second set of downlink reference signal resources associated with the measurement occasion 830 via at least one a CSI report, MAC-CE communication, or a similar communication. For example, in aspects in which the UE 120 receives, from the network node 110, a CSI report setting (e.g., CSI report setting 720), the predicted channel characteristics associated with the second set of downlink reference signal resources (e.g., the Set A beams) associated with the measurement occasion 830 may be reported via a CSI report configured by, or otherwise associated with, the CSI report setting.

Additionally, or alternatively, in the operations shown in connection with reference number 840, the UE 120 may report, to the network node 110, an indication of a subset of the second set of downlink reference signal resources. For example, the UE 120 may report only downlink reference signal resources that are associated with a quantity (sometimes referred to as K) of highest-strength predicted channel characteristics. More particularly, the UE 120 may report the predicted top K resources in terms of the resources' respective L1-RSRP and/or L1-SINR strengths. In such aspects, the UE 120 may be configured with the quantity (e.g., K) of downlink reference signal resources to be reported. For example, via the configuration information described above in connection with reference number 815 and/or via similar signaling (e.g., an RRC message, a MAC-CE, and/or DCI), the network node 110 may indicate the quantity (e.g., K) of downlink reference signal resources that are to be reported in the operations shown in connection with reference number 840 (e.g., via a CSI report).

Moreover, in some aspects, the UE 120 may report the indication of the subset of the second set of downlink reference signal resources (e.g., the K top resources) without reporting corresponding channel characteristics for each resource (e.g., without reporting corresponding L1-RSRP and/or L1-SINR measurement values for the reported resources). Put another way, the operations shown in connection with reference number 840 may include omitting an indication of the predicted channel characteristics associated with the subset of the second set of downlink reference signal resources. By reporting only the predicted top K downlink reference signal resources and/or by omitting measurement values associated with the reported predicted downlink reference signal resources, the UE 120 and/or the network node 110 may conserve power, computing, and network resources otherwise needed to report channel characteristics associated with all predicted downlink reference signal resources.

Based at least in part on the network node 110 signaling, to the UE 120, an indication of a technique for determining the Set C beams (as shown by reference number 810), the UE 120 and/or the network node 110 may conserve computing, power, network, and/or communication resources that may have otherwise been consumed communicating based at least in part on channel predictions determined based at least in part on Set C beams chosen autonomously by the UE 120 and/or determined according to UE 120-specific implementation. For example, based at least in part on the network node 110 signaling, to the UE 120, an indication of a technique for determining the Set C beams, the UE 120 and the network node 110 may communicate with a reduced error rate, which may conserve computing, power, network, and/or communication resources that may have otherwise been consumed to detect and/or correct communication errors.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with channel characteristic predictions based at least in part on a subset of downlink reference signal resources.

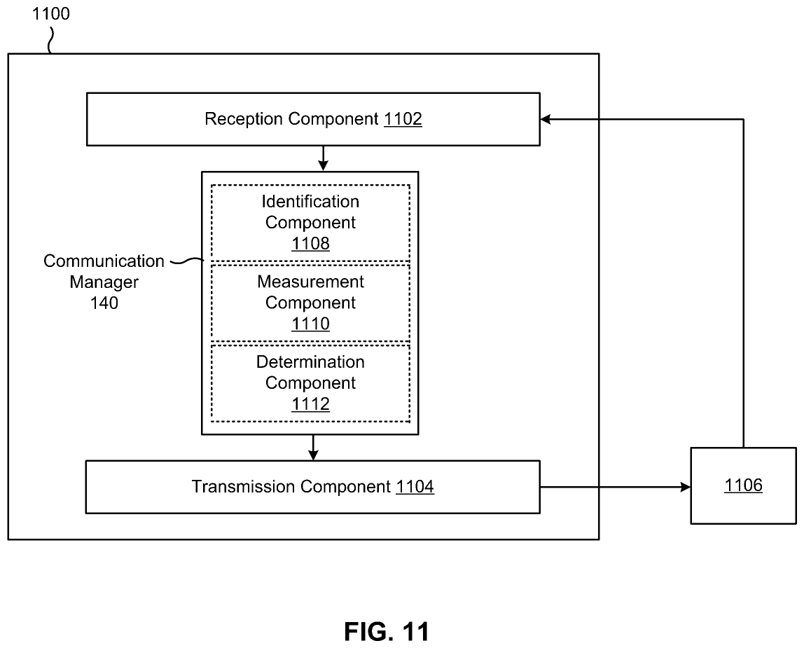

As shown in FIG. 9, in some aspects, process 900 may include receiving, from a network node (e.g., network node 110), an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion (block 910). For example, the UE (e.g., using communication manager 140 and/or reception component 1102, depicted in FIG. 11) may receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion, as described above.

As further shown in FIG. 9, in some aspects, process 900 may include identifying the subset of the first set of downlink reference signal resources based at least in part on the technique for identifying the subset of the first set of downlink reference signal resources (block 920). For example, the UE (e.g., using communication manager 140 and/or identification component 1108, depicted in FIG. 11) may identify the subset of the first set of downlink reference signal resources based at least in part on the technique for identifying the subset of the first set of downlink reference signal resources, as described above.

Process 900 may include additional aspects, such as any single aspect or any combination of aspects described below and/or in connection with one or more other processes described elsewhere herein.

In a first aspect, the technique for identifying the subset of the first set of downlink reference signal resources is associated with one of a formula or a machine-learning model.

In a second aspect, alone or in combination with the first aspect, process 900 includes measuring channel characteristics associated with the subset of the first set of downlink reference signal resources, wherein the channel characteristics associated with the subset of the first set of downlink reference signal resources are associated with the input to the model used to determine the predicted channel characteristics associated with the second set of downlink reference signal resources.

In a third aspect, alone or in combination with one or more of the first and second aspects, the channel characteristics associated with the subset of the first set of downlink reference signal resources are associated with at least one of a reference signal received power measurement, a signal-to-noise-plus-interference ratio, a precoding matrix indicator, a channel quality indicator, a channel state information reference signal resource indicator, or a rank indicator.

In a fourth aspect, alone or in combination with one or more of the first through third aspects, the technique for identifying the subset of the first set of downlink reference signal resources is based at least in part on one or more previously determined subsets of the first set of downlink reference signal resources associated with one or more measurement occasions preceding the measurement occasion.

In a fifth aspect, alone or in combination with one or more of the first through fourth aspects, the technique for identifying the subset of the first set of downlink reference signal resources is further based at least in part on channel characteristics associated with the one or more previously determined subsets of the first set of downlink reference signal resources.

In a sixth aspect, alone or in combination with one or more of the first through fifth aspects, the technique for identifying the subset of the first set of downlink reference signal resources is based at least in part on at least one of a formula associated with the channel characteristics associated with the one or more previously determined subsets of the first set of downlink reference signal resources, or a machine-learning model associated with the channel characteristics associated with the one or more previously determined subsets of the first set of downlink reference signal resources.

In a seventh aspect, alone or in combination with one or more of the first through sixth aspects, the technique for identifying the subset of the first set of downlink reference signal resources is based at least in part on predicted channel characteristics of the second set of downlink reference signal resources associated with one or more measurement occasions preceding the measurement occasion.

In an eighth aspect, alone or in combination with one or more of the first through seventh aspects, the technique for identifying the subset of the first set of downlink reference signal resources is further based at least in part on at least one of a formula associated the predicted channel characteristics of the second set of downlink reference signal resources associated with the one or more measurement occasions preceding the measurement occasion, or a machine-learning model associated with the predicted channel characteristics of the second set of downlink reference signal resources associated with the one or more measurement occasions preceding the measurement occasion.

In a ninth aspect, alone or in combination with one or more of the first through eighth aspects, process 900 includes determining the predicted channel characteristics associated with the second set of downlink reference signal resources based at least in part on the subset of the first set of downlink reference signal resources.

In a tenth aspect, alone or in combination with one or more of the first through ninth aspects, process 900 includes reporting, to the network node, an indication of the predicted channel characteristics associated with the second set of downlink reference signal resources via at least one of a CSI report or a MAC-CE communication.

In an eleventh aspect, alone or in combination with one or more of the first through tenth aspects, the predicted channel characteristics associated with the second set of downlink reference signal resources are reported via the CSI report, and the indication of the technique for identifying the subset of the first set of downlink reference signal resources is received via a CSI report setting associated with the CSI report.

In a twelfth aspect, alone or in combination with one or more of the first through eleventh aspects, identifying the subset of the first set of downlink reference signal resources includes identifying at least one of resource identifiers associated with the subset of the first set of downlink reference signal resources, or channel characteristics associated with the subset of the first set of downlink reference signal resources.

In a thirteenth aspect, alone or in combination with one or more of the first through twelfth aspects, process 900 includes receiving, from the network node, a configuration of multiple CMR sets, wherein the subset of the first set of downlink reference signal resources is associated with a CMR set, of the multiple CMR sets.

In a fourteenth aspect, alone or in combination with one or more of the first through thirteenth aspects, process 900 includes receiving, from the network node, a CSI report setting associated with a CSI report used to report the predicted channel characteristics associated with the second set of downlink reference signal resources, wherein the CSI report setting indicates the multiple CMR sets.

In a fifteenth aspect, alone or in combination with one or more of the first through fourteenth aspects, identifying the subset of the first set of downlink reference signal resources includes identifying an identifier associated with the CMR set.

In a sixteenth aspect, alone or in combination with one or more of the first through fifteenth aspects, process 900 includes reporting, to the network node, an indication of a subset of the second set of downlink reference signal resources.

In a seventeenth aspect, alone or in combination with one or more of the first through sixteenth aspects, the subset of the second set of downlink reference signal resources includes downlink reference signal resources that are associated with a quantity of highest-strength predicted channel characteristics, of the predicted channel characteristics associated with the second set of downlink reference signal resources.

In an eighteenth aspect, alone or in combination with one or more of the first through seventeenth aspects, process 900 includes receiving, from the network node, configuration information indicating the quantity.

In a nineteenth aspect, alone or in combination with one or more of the first through eighteenth aspects, reporting the indication of the subset of the second set of downlink reference signal resources includes omitting an indication of the predicted channel characteristics associated with the subset of the second set of downlink reference signal resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with channel characteristic predictions based at least in part on a subset of downlink reference signal resources.

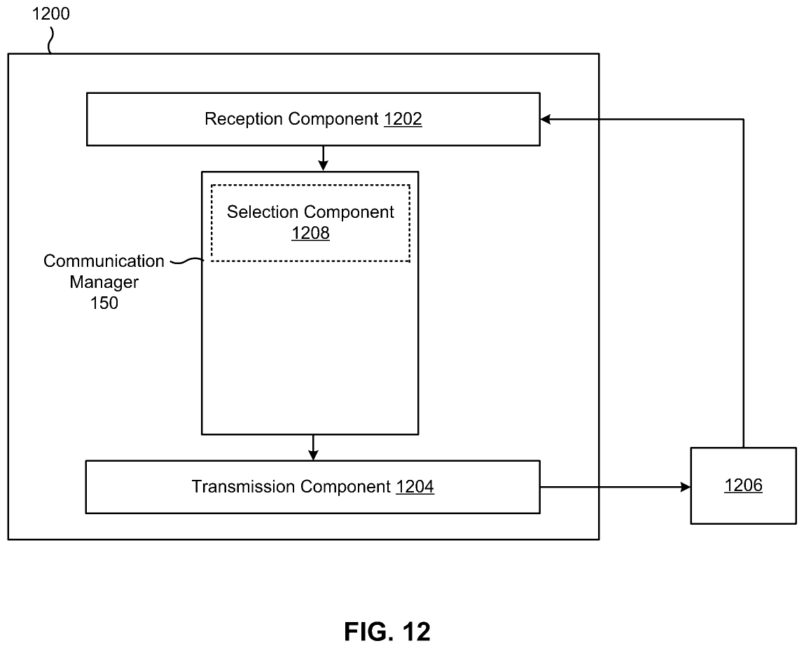

As shown in FIG. 10, in some aspects, process 1000 may include selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion (block 1010). For example, the network node (e.g., using communication manager 150 and/or selection component 1208, depicted in FIG. 12) may select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion, as described above.

As further shown in FIG. 10, in some aspects, process 1000 may include transmitting, to a UE (e.g., UE 120), an indication of the technique for identifying the subset of the first set of downlink reference signal resources (block 1020). For example, the network node (e.g., using communication manager 150 and/or transmission component 1204, depicted in FIG. 12) may transmit, to a UE, an indication of the technique for identifying the subset of the first set of downlink reference signal resources, as described above.

Process 1000 may include additional aspects, such as any single aspect or any combination of aspects described below and/or in connection with one or more other processes described elsewhere herein.

In a first aspect, the technique for identifying the subset of the first set of downlink reference signal resources is associated with one of a formula or a machine-learning model In a second aspect, alone or in combination with the first aspect, the technique for identifying the subset of the first set of downlink reference signal resources is based at least in part on one or more previously determined subsets of the first set of downlink reference signal resources associated with one or more measurement occasions preceding the measurement occasion.

In a third aspect, alone or in combination with one or more of the first and second aspects, the technique for identifying the subset of the first set of downlink reference signal resources is further based at least in part on channel characteristics associated with the one or more previously determined subsets of the first set of downlink reference signal resources.

In a fourth aspect, alone or in combination with one or more of the first through third aspects, the channel characteristics associated with the subset of the one or more previously determined subsets of the first set of downlink reference signal resources are associated with at least one of a reference signal received power measurement, a signal-to-noise-plus-interference ratio, a precoding matrix indicator, a channel quality indicator, a channel state information reference signal resource indicator, or a rank indicator.

In a fifth aspect, alone or in combination with one or more of the first through fourth aspects, the technique for identifying the subset of the first set of downlink reference signal resources is further based at least in part on at least one of a formula associated with channel characteristics associated with the one or more previously determined subsets of the first set of downlink reference signal resources, or a machine-learning model associated with the channel characteristics associated with the one or more previously determined subsets of the first set of downlink reference signal resources.

In a sixth aspect, alone or in combination with one or more of the first through fifth aspects, the technique for identifying the subset of the first set of downlink reference signal resources is based at least in part on predicted channel characteristics of the second set of downlink reference signal resources associated with one or more measurement occasions preceding the measurement occasion.

In a seventh aspect, alone or in combination with one or more of the first through sixth aspects, the technique for identifying the subset of the first set of downlink reference signal resources is further based at least in part on at least one of a formula associated with the predicted channel characteristics of the second set of downlink reference signal resources associated with the one or more measurement occasions preceding the measurement occasion, or a machine-learning model associated with the predicted channel characteristics of the second set of downlink reference signal resources associated with the one or more measurement occasions preceding the measurement occasion.

In an eighth aspect, alone or in combination with one or more of the first through seventh aspects, process 1000 includes receiving, from the UE, an indication of the predicted channel characteristics associated with the second set of downlink reference signal resources via at least one of a CSI report or a MAC-CE communication.

In a ninth aspect, alone or in combination with one or more of the first through eighth aspects, the predicted channel characteristics associated with the second set of downlink reference signal resources are received via the CSI report, and the indication of the technique for identifying the subset of the first set of downlink reference signal resources associated with the measurement occasion is transmitted via a CSI report setting associated with the CSI report.

In a tenth aspect, alone or in combination with one or more of the first through ninth aspects, the technique for identifying the subset of the first set of downlink reference signal resources identifies at least one of resource identifiers associated with the subset of the first set of downlink reference signal resources, or channel characteristics associated with the subset of the first set of downlink reference signal resources.

In an eleventh aspect, alone or in combination with one or more of the first through tenth aspects, process 1000 includes transmitting, to the UE, a configuration of multiple CMR sets, wherein the subset of the first set of downlink reference signal resources is associated with a CMR set, of the multiple CMR sets.

In a twelfth aspect, alone or in combination with one or more of the first through eleventh aspects, process 1000 includes transmitting, to the UE, a CSI report setting associated with a CSI report used to report the predicted channel characteristics associated with the second set of downlink reference signal resources, wherein the CSI report setting indicates the multiple CMR sets.

In a thirteenth aspect, alone or in combination with one or more of the first through twelfth aspects, the technique for identifying the subset of the first set of downlink reference signal resources identifies an identifier associated with the CMR set.

In a fourteenth aspect, alone or in combination with one or more of the first through thirteenth aspects, process 1000 includes receiving, from the UE, an indication of a subset of the second set of downlink reference signal resources.

In a fifteenth aspect, alone or in combination with one or more of the first through fourteenth aspects, the subset of the second set of downlink reference signal resources includes downlink reference signal resources that are associated with a quantity of highest-strength predicted channel characteristics, of the predicted channel characteristics associated with the second set of downlink reference signal resources.

In a sixteenth aspect, alone or in combination with one or more of the first through fifteenth aspects, process 1000 includes receiving, from the network node, configuration information indicating the quantity.

In a seventeenth aspect, alone or in combination with one or more of the first through sixteenth aspects, the indication of the subset of the second set of downlink reference signal resources omits an indication of the predicted channel characteristics associated with the subset of the second set of downlink reference signal resources.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE 120, or a UE 120 may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE 120, a network node 110, or another wireless communication device) using the reception component 1102 and the transmission component 1104. As further shown, the apparatus 1100 may include the communication manager 140. The communication manager 140 may include one or more of an identification component 1108, a measurement component 1110, or a determination component 1112, among other examples.

In some aspects, the apparatus 1100 may be configured to perform one or more operations described herein in connection with FIGS. 7A-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The reception component 1102 may receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The identification component 1108 may identify the subset of the first set of downlink reference signal resources based at least in part on the technique for identifying the subset of the first set of downlink reference signal resources.

The measurement component 1110 may measure channel characteristics associated with the subset of the first set of downlink reference signal resources, wherein the channel characteristics associated with the subset of the first set of downlink reference signal resources are associated with the input to the model used to determine the predicted channel characteristics associated with the second set of downlink reference signal resources.

The determination component 1112 may determine the predicted channel characteristics associated with the second set of downlink reference signal resources associated with the measurement occasion based at least in part on the subset of the first set of downlink reference signal resources.

The transmission component 1104 may report, to the network node, an indication of the predicted channel characteristics associated with the second set of downlink reference signal resources associated with the measurement occasion via at least one of a CSI report or a MAC-CE communication.

The reception component 1102 may receive, from the network node, a configuration of multiple CMR sets, wherein the subset of the first set of downlink reference signal resources is associated with a CMR set, of the multiple CMR sets.

The reception component 1102 may receive, from the network node, a CSI report setting associated with a CSI report used to report the predicted channel characteristics associated with the second set of downlink reference signal resources associated with the measurement occasion, wherein the CSI report setting indicates the multiple CMR sets.

The transmission component 1104 may report, to the network node, an indication of a subset of the second set of downlink reference signal resources.

The reception component 1102 may receive, from the network node, configuration information indicating a quantity of highest-strength predicted channel characteristics, of the predicted channel characteristics associated with the second set of downlink reference signal resources.

The identification component 1108 may omit an indication of the predicted channel characteristics associated with the subset of the second set of downlink reference signal resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node 110, or a network node 110 may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE 120, a network node 110, or another wireless communication device) using the reception component 1202 and the transmission component 1204. As further shown, the apparatus 1200 may include the communication manager 150. The communication manager 150 may include a selection component 1208, among other examples.

In some aspects, the apparatus 1200 may be configured to perform one or more operations described herein in connection with FIGS. 7A-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node 110 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node 110 described in connection with FIG. 2. In some aspects, the transmission component 1204 may be co-located with the reception component 1202 in a transceiver.

The selection component 1208 may select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion. The transmission component 1204 may transmit, to a UE, an indication of the technique for identifying the subset of a first set of downlink reference signal resources associated with the measurement occasion.

The reception component 1202 may receive, from the UE, an indication of the predicted channel characteristics associated with the second set of downlink reference signal resources associated with the measurement occasion via at least one of a CSI report or a MAC-CE communication.

The transmission component 1204 may transmit, to the UE, a configuration of multiple CMR sets, wherein the subset of the first set of downlink reference signal resources is associated with a CMR set, of the multiple CMR sets.

The transmission component 1204 may transmit, to the UE, a CSI report setting associated with a CSI report used to report the predicted channel characteristics associated with the second set of downlink reference signal resources associated with the measurement occasion, wherein the CSI report setting indicates the multiple CMR sets.

The reception component 1202 may receive, from the UE, an indication of a subset of the second set of downlink reference signal resources.

The transmission component 1204 may transmit, to the UE, configuration information indicating a quantity of highest-strength predicted channel characteristics, of the predicted channel characteristics associated with the second set of downlink reference signal resources.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a UE, comprising: receiving, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and identifying the subset of the first set of downlink reference signal resources based at least in part on the technique for identifying the subset of the first set of downlink reference signal resources.
Aspect 2: The method of Aspect 1, wherein the technique for identifying the subset of the first set of downlink reference signal resources is associated with one of a formula or a machine-learning model.
Aspect 3: The method of any of Aspects 1-2, further comprising measuring channel characteristics associated with the subset of the first set of downlink reference signal resources, wherein the channel characteristics associated with the subset of the first set of downlink reference signal resources are associated with the input to the model used to determine the predicted channel characteristics associated with the second set of downlink reference signal resources.
Aspect 4: The method of Aspect 3, wherein the channel characteristics associated with the subset of the first set of downlink reference signal resources are associated with at least one of: a reference signal received power measurement, a signal-to-noise-plus-interference ratio, a precoding matrix indicator, a channel quality indicator, a channel state information reference signal resource indicator, or a rank indicator.
Aspect 5: The method of any of Aspects 1-4, wherein the technique for identifying the subset of the first set of downlink reference signal resources is based at least in part on one or more previously determined subsets of the first set of downlink reference signal resources associated with one or more measurement occasions preceding the measurement occasion.
Aspect 6: The method of Aspect 5, wherein the technique for identifying the subset of the first set of downlink reference signal resources is further based at least in part on channel characteristics associated with the one or more previously determined subsets of the first set of downlink reference signal resources.
Aspect 7: The method of Aspect 6, wherein the technique for identifying the subset of the first set of downlink reference signal resources is based at least in part on at least one of: a formula associated with the channel characteristics associated with the one or more previously determined subsets of the first set of downlink reference signal resources, or a machine-learning model associated with the channel characteristics associated with the one or more previously determined subsets of the first set of downlink reference signal resources.
Aspect 8: The method of any of Aspects 1-7, wherein the technique for identifying the subset of the first set of downlink reference signal resources is based at least in part on predicted channel characteristics of the second set of downlink reference signal resources associated with one or more measurement occasions preceding the measurement occasion.
Aspect 9: The method of Aspect 8, wherein the technique for identifying the subset of the first set of downlink reference signal resources is further based at least in part on at least one of: a formula associated the predicted channel characteristics of the second set of downlink reference signal resources associated with the one or more measurement occasions preceding the measurement occasion, or a machine-learning model associated with the predicted channel characteristics of the second set of downlink reference signal resources associated with the one or more measurement occasions preceding the measurement occasion.
Aspect 10: The method of any of Aspects 1-9, further comprising determining the predicted channel characteristics associated with the second set of downlink reference signal resources based at least in part on the subset of the first set of downlink reference signal resources.
Aspect 11: The method of any of Aspects 1-10, further comprising reporting, to the network node, an indication of the predicted channel characteristics associated with the second set of downlink reference signal resources via at least one of a CSI report or a MAC-CE communication.
Aspect 12: The method of Aspect 9, wherein the predicted channel characteristics associated with the second set of downlink reference signal resources are reported via the CSI report, and wherein the indication of the technique for identifying the subset of the first set of downlink reference signal resources is received via a CSI report setting associated with the CSI report.
Aspect 13: The method of any of Aspects 1-12, wherein identifying the subset of the first set of downlink reference signal resources includes identifying at least one of: resource identifiers associated with the subset of the first set of downlink reference signal resources, or channel characteristics associated with the subset of the first set of downlink reference signal resources.
Aspect 14: The method of any of Aspects 1-13, further comprising receiving, from the network node, a configuration of multiple CMR sets, wherein the subset of the first set of downlink reference signal resources is associated with a CMR set, of the multiple CMR sets.
Aspect 15: The method of Aspect 14, further comprising receiving, from the network node, a CSI report setting associated with a CSI report used to report the predicted channel characteristics associated with the second set of downlink reference signal resources, wherein the CSI report setting indicates the multiple CMR sets.
Aspect 16: The method of Aspect 15, wherein identifying the subset of the first set of downlink reference signal resources includes identifying an identifier associated with the CMR set.
Aspect 17: The method of any of Aspects 1-16, further comprising reporting, to the network node, an indication of a subset of the second set of downlink reference signal resources.
Aspect 18: The method of Aspect 17, wherein the subset of the second set of downlink reference signal resources includes downlink reference signal resources that are associated with a quantity of highest-strength predicted channel characteristics, of the predicted channel characteristics associated with the second set of downlink reference signal resources.
Aspect 19: The method of Aspect 18, further comprising receiving, from the network node, configuration information indicating the quantity.
Aspect 20: The method of any of Aspects 17-19, wherein reporting the indication of the subset of the second set of downlink reference signal resources includes omitting an indication of the predicted channel characteristics associated with the subset of the second set of downlink reference signal resources.
Aspect 21: A method of wireless communication performed by a network node, comprising: selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and transmitting, to a UE, an indication of the technique for identifying the subset of the first set of downlink reference signal resources.
Aspect 22: The method of Aspect 21, wherein the technique for identifying the subset of the first set of downlink reference signal resources is associated with one of a formula or a machine-learning model.
Aspect 23: The method of any of Aspects 21-22, wherein the technique for identifying the subset of the first set of downlink reference signal resources is based at least in part on one or more previously determined subsets of the first set of downlink reference signal resources associated with one or more measurement occasions preceding the measurement occasion.
Aspect 24: The method of Aspect 23, wherein the technique for identifying the subset of the first set of downlink reference signal resources is further based at least in part on channel characteristics associated with the one or more previously determined subsets of the first set of downlink reference signal resources.
Aspect 25: The method of Aspect 24, wherein the channel characteristics associated with the one or more previously determined subsets of the first set of downlink reference signal resources are associated with at least one of: a reference signal received power measurement, a signal-to-noise-plus-interference ratio, a precoding matrix indicator, a channel quality indicator, a channel state information reference signal resource indicator, or a rank indicator.
Aspect 26: The method of any of Aspects 23-25, wherein the technique for identifying the subset of the first set of downlink reference signal resources is further based at least in part on at least one of: a formula associated with channel characteristics associated with the one or more previously determined subsets of the first set of downlink reference signal resources, or a machine-learning model associated with the channel characteristics associated with one or more previously determined subsets of the first set of downlink reference signal resources.
Aspect 27: The method of any of Aspects 21-26, wherein the technique for identifying the subset of the first set of downlink reference signal resources is based at least in part on predicted channel characteristics of the second set of downlink reference signal resources associated with one or more measurement occasions preceding the measurement occasion.
Aspect 28: The method of Aspect 27, wherein the technique for identifying the subset of the first set of downlink reference signal resources is further based at least in part on at least one of: a formula associated with the predicted channel characteristics of the second set of downlink reference signal resources associated with the one or more measurement occasions preceding the measurement occasion, or a machine-learning model associated with the predicted channel characteristics of the second set of downlink reference signal resources associated with the one or more measurement occasions preceding the measurement occasion.
Aspect 29: The method of any of Aspects 21-28, further comprising receiving, from the UE, an indication of the predicted channel characteristics associated with the second set of downlink reference signal resources via at least one of a CSI report or a MAC-CE communication.
Aspect 30: The method of Aspect 29, wherein the predicted channel characteristics associated with the second set of downlink reference signal resources associated with the measurement occasion are received via the CSI report, and wherein the indication of the technique for identifying the subset of the first set of downlink reference signal resources associated with the measurement occasion is transmitted via a CSI report setting associated with the CSI report.
Aspect 31: The method of any of Aspects 21-30, wherein the technique for identifying the subset of the first set of downlink reference signal resources identifies at least one of: resource identifiers associated with the subset of the first set of downlink reference signal resources, or channel characteristics associated with the subset of the first set of downlink reference signal resources.
Aspect 32: The method of any of Aspects 21-31, further comprising transmitting, to the UE, a configuration of multiple CMR sets, wherein the subset of the first set of downlink reference signal resources is associated with a CMR set, of the multiple CMR sets.
Aspect 33: The method of Aspect 32, further comprising transmitting, to the UE, a CSI report setting associated with a CSI report used to report the predicted channel characteristics associated with the second set of downlink reference signal resources, wherein the CSI report setting indicates the multiple CMR sets.
Aspect 34: The method of Aspect 33, wherein the technique for identifying the subset of the first set of downlink reference signal resources identifies an identifier associated with the CMR set.
Aspect 35: The method of any of Aspects 21-34, further comprising receiving, from the UE, an indication of a subset of the second set of downlink reference signal resources.
Aspect 36: The method of Aspect 35, wherein the subset of the second set of downlink reference signal resources includes downlink reference signal resources that are associated with a quantity of highest-strength predicted channel characteristics, of the predicted channel characteristics associated with the second set of downlink reference signal resources.
Aspect 37: The method of Aspect 36, further comprising transmitting, to the UE, configuration information indicating the quantity.
Aspect 38: The method of any of Aspects 35-37, wherein the indication of the subset of downlink reference signal resources omits an indication of the predicted channel characteristics associated with the subset of the second set of downlink reference signal resources.
Aspect 39: An apparatus for wireless communication at a device, comprising a processor; memory coupled with the processor; and instructions stored in the memory and executable by the processor to cause the apparatus to perform the method of one or more of Aspects 1-20.
Aspect 40: A device for wireless communication, comprising a memory and one or more processors coupled to the memory, the one or more processors configured to perform the method of one or more of Aspects 1-20.
Aspect 41: An apparatus for wireless communication, comprising at least one means for performing the method of one or more of Aspects 1-20.
Aspect 42: A non-transitory computer-readable medium storing code for wireless communication, the code comprising instructions executable by a processor to perform the method of one or more of Aspects 1-20.
Aspect 43: A non-transitory computer-readable medium storing a set of instructions for wireless communication, the set of instructions comprising one or more instructions that, when executed by one or more processors of a device, cause the device to perform the method of one or more of Aspects 1-20.
Aspect 44: An apparatus for wireless communication at a device, comprising a processor; memory coupled with the processor; and instructions stored in the memory and executable by the processor to cause the apparatus to perform the method of one or more of Aspects 21-38.
Aspect 45: A device for wireless communication, comprising a memory and one or more processors coupled to the memory, the one or more processors configured to perform the method of one or more of Aspects 21-38.
Aspect 46: An apparatus for wireless communication, comprising at least one means for performing the method of one or more of Aspects 21-38.
Aspect 47: A non-transitory computer-readable medium storing code for wireless communication, the code comprising instructions executable by a processor to perform the method of one or more of Aspects 21-38.
Aspect 48: A non-transitory computer-readable medium storing a set of instructions for wireless communication, the set of instructions comprising one or more instructions that, when executed by one or more processors of a device, cause the device to perform the method of one or more of Aspects 21-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and
identify the subset of the first set of downlink reference signal resources based at least in part on the technique for identifying the subset of the first set of downlink reference signal resources.

2. The UE of claim 1, wherein the one or more processors are further configured to report, to the network node, an indication of a subset of the second set of downlink reference signal resources.

3. The UE of claim 2, wherein the subset of the second set of downlink reference signal resources includes downlink reference signal resources that are associated with a quantity of highest-strength predicted channel characteristics, of the predicted channel characteristics associated with the second set of downlink reference signal resources.

4. The UE of claim 3, wherein the one or more processors are further configured to receive, from the network node, configuration information indicating the quantity.

5. The UE of claim 2, wherein, to report the indication of the subset of the second set of downlink reference signal resources, the one or more processors are further configured to omit an indication of the predicted channel characteristics associated with the subset of the second set of downlink reference signal resources.

6. The UE of claim 1, wherein the technique for identifying the subset of the first set of downlink reference signal resources is associated with one of a formula or a machine-learning model.

7. The UE of claim 1, wherein the one or more processors are further configured to measure channel characteristics associated with the subset of the first set of downlink reference signal resources, wherein the channel characteristics associated with the subset of the first set of downlink reference signal resources are associated with the input to the model used to determine the predicted channel characteristics associated with the second set of downlink reference signal resources.

8. The UE of claim 7, wherein the channel characteristics associated with the subset of the first set of downlink reference signal resources are associated with at least one of:
a reference signal received power measurement,
a signal-to-noise-plus-interference ratio,
a precoding matrix indicator,
a channel quality indicator,
a channel state information reference signal resource indicator, or
a rank indicator.

9. The UE of claim 1, wherein the technique for identifying the subset of the first set of downlink reference signal resources is based at least in part on one or more previously determined subsets of the first set of downlink reference signal resources associated with one or more measurement occasions preceding the measurement occasion.

10. The UE of claim 9, wherein the technique for identifying the subset of the first set of downlink reference signal resources is further based at least in part on channel characteristics associated with the one or more previously determined subsets of the first set of downlink reference signal resources.

11. The UE of claim 10, wherein the technique for identifying the subset of the first set of downlink reference signal resources is based at least in part on at least one of:
a formula associated with the channel characteristics associated with the one or more previously determined subsets of the first set of downlink reference signal resources, or
a machine-learning model associated with the channel characteristics associated with the one or more previously determined subsets of the first set of downlink reference signal resources.

12. The UE of claim 1, wherein the technique for identifying the subset of the first set of downlink reference signal resources is based at least in part on predicted channel characteristics of the second set of downlink reference signal resources associated with one or more measurement occasions preceding the measurement occasion.

13. The UE of claim 12, wherein the technique for identifying the subset of the first set of downlink reference signal resources is further based at least in part on at least one of:
a formula associated the predicted channel characteristics of the second set of downlink reference signal resources associated with the one or more measurement occasions preceding the measurement occasion, or
a machine-learning model associated with the predicted channel characteristics of the second set of downlink reference signal resources associated with the one or more measurement occasions preceding the measurement occasion.

14. The UE of claim 1, wherein the one or more processors are further configured to determine the predicted channel characteristics associated with the second set of downlink reference signal resources based at least in part on the subset of the first set of downlink reference signal resources.

15. The UE of claim 1, wherein the one or more processors are further configured to report, to the network node, an indication of the predicted channel characteristics associated with the second set of downlink reference signal resources via at least one of a channel state information (CSI) report or a medium access control (MAC) control element (MAC-CE) communication.

16. The UE of claim 15, wherein, to report the indication of the predicted channel characteristics associated with the second set of downlink reference signal resources, the one or more processors are further configured to report the indication of the predicted channel characteristics associated with the second set of downlink reference signal resources via the CSI report, and
wherein, to receive the indication of the technique for identifying the subset of the first set of downlink reference signal resources, the one or more processors are further configured to receive the indication of the technique for identifying the subset of the first set of downlink reference signal resources via a CSI report setting associated with the CSI report.

17. The UE of claim 1, wherein the one or more processors, to identify the subset of the first set of downlink reference signal resources, are configured to identify at least one of:
resource identifiers associated with the subset of the first set of downlink reference signal resources, or
channel characteristics associated with the subset of the first set of downlink reference signal resources.

18. The UE of claim 1, wherein the one or more processors are further configured to receive, from the network node, a configuration of multiple channel measurement resource (CMR) sets, wherein the subset of the first set of downlink reference signal resources is associated with a CMR set, of the multiple CMR sets.

19. The UE of claim 18, wherein the one or more processors are further configured to receive, from the network node, a channel state information (CSI) report setting associated with a CSI report used to report the predicted channel characteristics associated with the second set of downlink reference signal resources, wherein the CSI report setting indicates the multiple CMR sets.

20. The UE of claim 19, wherein the one or more processors, to identify the subset of the first set of downlink reference signal resources, are configured to identify an identifier associated with the CMR set.

21. A network node for wireless communication, comprising:
one or more memories; and
one or more processors, coupled to the one or more memories, configured to:
select a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and
transmit, to a user equipment (UE), an indication of the technique for identifying the subset of the first set of downlink reference signal resources.

22. The network node of claim 21, wherein the one or more processors are further configured to receive, from the UE, an indication of a subset of the second set of downlink reference signal resources.

23. The network node of claim 22, wherein the subset of the second set of downlink reference signal resources includes downlink reference signal resources that are associated with a quantity of highest-strength predicted channel characteristics, of the predicted channel characteristics associated with the second set of downlink reference signal resources.

24. The network node of claim 23, wherein the one or more processors are further configured to transmit, to the UE, configuration information indicating the quantity.

25. The network node of claim 22, wherein the indication of the subset of downlink reference signal resources omits an indication of the predicted channel characteristics associated with the subset of the second set of downlink reference signal resources.

26. The network node of claim 21, wherein the technique for identifying the subset of the first set of downlink reference signal resources is associated with one of a formula or a machine-learning model.

27. A method of wireless communication performed by a user equipment (UE), comprising:
receiving, from a network node, an indication of a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and
identifying the subset of the first set of downlink reference signal resources based at least in part on the technique for identifying the subset of the first set of downlink reference signal resources.

28. The method of claim 27, further comprising reporting, to the network node, an indication of a subset of the second set of downlink reference signal resources,
wherein the subset of the second set of downlink reference signal resources includes downlink reference signal resources that are associated with a quantity of highest-strength predicted channel characteristics, of the predicted channel characteristics associated with the second set of downlink reference signal resources, and
wherein reporting the indication of the subset of downlink reference signal resources includes omitting an indication of the predicted channel characteristics associated with the subset of the second set of downlink reference signal resources.

29. A method of wireless communication performed by a network node, comprising:
selecting a technique for identifying a subset of a first set of downlink reference signal resources associated with a measurement occasion, wherein the subset of the first set of downlink reference signal resources is associated with input to a model used to determine predicted channel characteristics associated with a second set of downlink reference signal resources associated with the measurement occasion; and
transmitting, to a user equipment (UE), an indication of the technique for identifying the subset of the first set of downlink reference signal resources.

30. The method of claim 29, further comprising receiving, from the UE, an indication of a subset of the second set of downlink reference signal resources,
wherein the subset of the second set of downlink reference signal resources includes downlink reference signal resources that are associated with a quantity of highest-strength predicted channel characteristics, of the predicted channel characteristics associated with the second set of downlink reference signal resources, and
wherein reporting the indication of the subset of downlink reference signal resources includes omitting an indication of the predicted channel characteristics associated with the subset of the second set of downlink reference signal resources.
